(19) United States
(12) Patent Application Publication
(10) Pub. No.: US 2025/0193275 A1
(43) Pub. Date: Jun. 12, 2025

(54) COMPUTING POWER TASK MIGRATION METHOD AND APPARATUS, AND DEVICE

(71) Applicant: VIVO MOBILE COMMUNICATION CO., LTD., Dongguan (CN)

(72) Inventor: Xiaowen SUN, Dongguan (CN)

(21) Appl. No.: 19/054,937

(22) Filed: Feb. 17, 2025

Related U.S. Application Data
(63) Continuation of application No. PCT/CN2023/112479, filed on Aug. 11, 2023.

(30) Foreign Application Priority Data
Aug. 17, 2022 (CN) 202210987882.X

(51) Int. Cl. H04L 67/1008; H04L 67/1012

(52) U.S. Cl. CPC H04L 67/1008; H04L 67/1012

(57) ABSTRACT

This application discloses a computing power task migration method and apparatus, and a device, and pertains to the field of communication technologies. The computing power task migration method in embodiments of this application includes: determining, by a first network side device, a target task on which computing power migration needs to be performed; determining, by the first network side device, a target computing power node for the computing power migration of the target task; and executing, by the first network side device, a procedure of migrating the target task to the target computing power node.

### CROSS-REFERENCE TO RELATED APPLICATIONS

This application is a continuation of International Patent Application No. PCT/CN2023/112479, filed on Aug. 11, 2023, which claims priority to Chinese Patent Application No. 202210987882.X, filed with the China National Intellectual Property Administration on Aug. 17, 2022 and entitled “COMPUTING POWER TASK MIGRATION METHOD AND APPARATUS, AND DEVICE”, both of which are incorporated herein by reference in their entireties.

### TECHNICAL FIELD

This application pertains to the field of communication technologies, and specifically relates to a computing power task migration method and apparatus, and a device.

### BACKGROUND

Generally, after a terminal or a network initiates a computing power service request, the network allocates a computing power server (or node) that can meet a computing power task requirement to the terminal or the network, to execute a computing power task of the terminal.

If the computing power task has been allocated to the computing power node and is in a working state, but in an execution process of the computing power task, the terminal for the computing power task may move, or the computing power node is down, or the computing power task of the computing power node suddenly increases.

### SUMMARY

Embodiments of this application provide a computing power task migration method and apparatus, and a device.

According to a first aspect, a computing power task migration method is provided, including:
determining, by a first network side device, a target task on which computing power migration needs to be performed;
determining, by the first network side device, a target computing power node for the computing power migration of the target task; and
executing, by the first network side device, a procedure of migrating the target task to the target computing power node.

According to a second aspect, a computing power task migration method is provided, including:
sending, by a first terminal, a computing power migration request to a first network side device, where the computing power migration request is used to request to perform computing power migration on at least one task, the computing power migration request is further used to trigger the first network side device to determine a target computing power node for computing power migration of a target task, and the target task is a task indicated by the computing power migration request.

According to a third aspect, a computing power task migration method is provided, including:
reporting, by a computing power node, computing power capability information to a first network side device.

According to a fourth aspect, a computing power task migration method is provided, including:
receiving, by a second network side device, migration information sent by a first network side device;
sending, by the second network side device, a deregistration indication to a terminal corresponding to a target task, where the deregistration indication is used to trigger a terminal to initiate network deregistration, and the target task is a computing power task on which computing power migration needs to be performed; and
interacting, by the second network side device, with the first network side device and the terminal, executing network deregistration of the terminal on a network slice corresponding to a source computing power node and network re-registration on a network slice corresponding to a target computing power node, and migrating the target task to the target computing power node, where
the source computing power node is a computing power node before computing power migration is performed on the target task of the terminal, and the target computing power node is a computing power node after computing power migration is performed on the target task of the terminal.

According to a fifth aspect, a computing power task migration apparatus is provided, including:
a task determining module, configured to determine a target task on which computing power migration needs to be performed;
a target computing power node determining module, configured to determine a target computing power node for the computing power migration of the target task; and
a first execution module, configured to execute a procedure of migrating the target task to the target computing power node.

According to a sixth aspect, a computing power task migration apparatus is provided, including:
a first sending module, configured to send a computing power migration request to a first network side device, where the computing power migration request is used to request to perform computing power migration on at least one task, the computing power migration request is further used to trigger the first network side device to determine a target computing power node for computing power migration of a target task, and the target task is a task indicated by the computing power migration request.

According to a seventh aspect, a computing power task migration apparatus is provided, including:
a first reporting module, configured to report computing power capability information to a first network side device.

According to an eighth aspect, a computing power task migration apparatus is provided, including:
a migration information receiving module, configured to receive migration information sent by a first network side device;
a deregistration sending module, configured to send a deregistration indication to a terminal corresponding to a target task, where the deregistration indication is used to trigger a terminal to initiate network deregistration, and the target task is a computing power task on which computing power migration needs to be performed; and
a third execution module, configured to: interact with the first network side device and the terminal, execute network deregistration of the terminal on a network slice corresponding to a source computing power node and network re-registration on a network slice corresponding to a target computing power node, and migrate the target task to the target computing power node, where
the source computing power node is a computing power node before computing power migration is performed on the target task of the terminal, and the target computing power node is a computing power node after computing power migration is performed on the target task of the terminal.

According to a ninth aspect, a terminal device is provided. The terminal includes a processor and a memory, the memory stores a program or an instruction that can be run on the processor, and the program or the instruction is executed by the processor to implement the steps of the method in the second aspect.

According to a tenth aspect, a network side device is provided, including a processor and a memory. The memory stores a program or an instruction that can be run on the processor, and the program or the instruction is executed by the processor to implement the steps of the method in the first aspect, the third aspect, or the fourth aspect.

According to an eleventh aspect, a computing power task migration system is provided, including a terminal and a network side device. The terminal device may be configured to execute the steps of the computing power task migration method in the second aspect, and the network side device may be configured to execute the steps of the computing power task migration method in the first aspect, the third aspect, or the fourth aspect.

According to a twelfth aspect, a readable storage medium is provided. The readable storage medium stores a program or an instruction, and the program or the instruction is executed by a processor to implement the steps of the method in the first aspect, the second aspect, the third aspect, or the fourth aspect.

According to a thirteenth aspect, a chip is provided. The chip includes a processor and a communication interface, the communication interface is coupled to the processor, and the processor is configured to run a program or an instruction to implement the method in the first aspect, the second aspect, the third aspect, or the fourth aspect.

According to a fourteenth aspect, a computer program/program product is provided. The computer program/program product is stored in a storage medium, and the computer program/program product is executed by at least one processor to implement the steps of the method in the first aspect, the second aspect, the third aspect, or the fourth aspect.

According to a fifteenth aspect, an embodiment of this application provides a computing power task migration apparatus. The apparatus is configured to execute the steps of the method in the first aspect, the second aspect, the third aspect, or the fourth aspect.

In the embodiments of this application, the first network side device can determine the target task on which computing power migration needs to be performed, to determine the target computing power node for the computing power migration of the target task, and then execute the procedure of migrating the target task to the target computing power node. It can be learned that in the embodiments of this application, automatic migration of a computing power task can be implemented.

### BRIEF DESCRIPTION OF DRAWINGS

FIG. 1 is a block diagram of a wireless communication system to which the embodiments of this application can be applied;

FIG. 2 is a flowchart of a computing power task migration method according to an embodiment of this application;

FIG. 3 is a flowchart of another computing power task migration method according to an embodiment of this application;

FIG. 4 is a flowchart of another computing power task migration method according to an embodiment of this application;

FIG. 5 is a flowchart of another computing power task migration method according to an embodiment of this application;

FIG. 6 is a flowchart of an implementation 1 of a computing power task migration method according to an embodiment of this application;

FIG. 7 is a flowchart of an implementation 2 of a computing power task migration method according to an embodiment of this application;

FIG. 8 is a flowchart of an implementation 3 of a computing power task migration method according to an embodiment of this application;

FIG. 9 is a flowchart of an implementation 4 of a computing power task migration method according to an embodiment of this application;

FIG. 10 is a structural block diagram of a computing power task migration apparatus according to an embodiment of this application;

FIG. 11 is a structural block diagram of another computing power task migration apparatus according to an embodiment of this application;

FIG. 12 is a structural block diagram of another computing power task migration apparatus according to an embodiment of this application;

FIG. 13 is a structural block diagram of another computing power task migration apparatus according to an embodiment of this application;

FIG. 14 is a structural block diagram of a communication device according to an embodiment of this application;

FIG. 15 is a structural block diagram of a terminal device according to an embodiment of this application; and

FIG. 16 is a structural block diagram of a network side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th generation (6G) communication system.

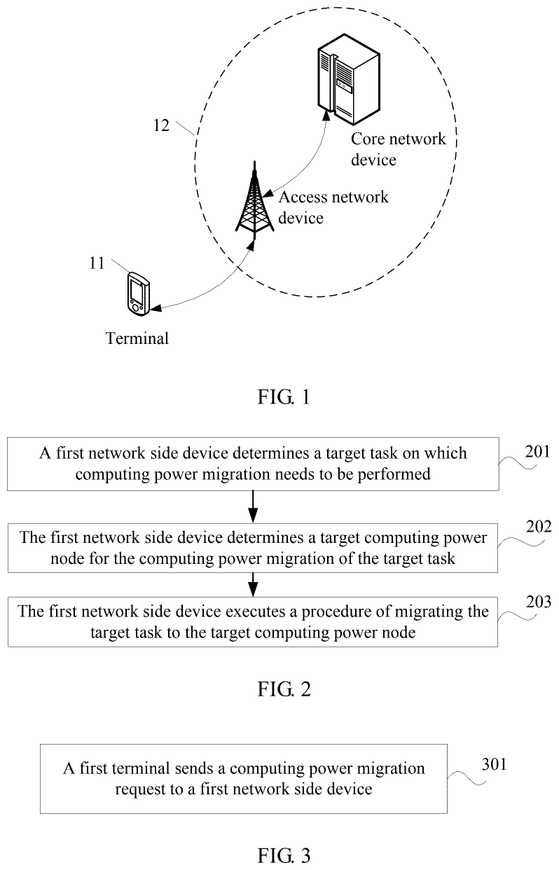

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a radio access network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the field. As long as a same technical effect is achieved, the base station is not limited to a specified technical term. It should be noted that, in this application, only a base station in an NR system is used as an example, and a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rule function unit (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (or L-NEF), a binding support function (BSF), an application function (AF), or the like. It should be noted that, in the embodiments of this application, only a core network device in an NR system is used as an example for description, and a specific type of the core network device is not limited.

If the computing power task has been allocated to the computing power node and is in a working state, but in an execution process of the computing power task, the terminal for the computing power task may move, or the computing power node is down, or the computing power task of the computing power node suddenly increases, thereby resulting in degradation of computing power task performance. However, in the prior art, when computing power task performance is degraded, there is no related method to resolve this problem.

Embodiments of this application provide a computing power task migration method and apparatus, and a device, to implement automatic migration of a computing power task when computing power task performance is degraded, thereby improving computing power task performance.

With reference to the accompanying drawings, the following describes in detail the computing power task migration method provided in the embodiments of this application by using some embodiments and application scenarios thereof.

According to a first aspect, an embodiment of this application provides a computing power task migration method. As shown in FIG. 2, the method may include the following steps 201 to 203:
Step 201: A first network side device determines a target task on which computing power migration needs to be performed.

The first network side device may be a computing service control function (CSCF).

After a terminal or a network side device initiates a computing power service request, a network allocates a computing power server (or node) that can meet a computing power task requirement to the terminal or the network side device to execute a corresponding computing power task. In some cases (for example, a computing power node is down or a computing power task increases suddenly), computing power task performance may be degraded during execution of the computing power task. For such a computing power task whose performance is degraded, computing power task migration may be performed to migrate the computing power task to a proper computing power node, thereby improving computing power task performance.

It can be learned from this that, in this embodiment of this application, the target task on which computing power migration needs to be performed may be a task whose computing power task performance is degraded. Whether computing power task performance is degraded, that is, whether computing power migration needs to be performed on the computing power task may be monitored and initiated by the terminal, or may be monitored and initiated by the first network side device (for example, a CSCF). A specific method is described in detail later.

Step 202: The first network side device determines a target computing power node for the computing power migration of the target task.

The target computing power node is a server or a node that can meet a requirement of the target task. That is, the target computing power node may provide a corresponding computing power service for the target task, so that the target task can be successfully executed.

Step 203: The first network side device executes a procedure of migrating the target task to the target computing power node.

It can be learned from the foregoing steps 201 to 203 that, in this embodiment of this application, the first network side device can determine the target task on which computing power migration needs to be performed, to determine the target computing power node for the computing power migration of the target task, and then execute the procedure of migrating the target task to the target computing power node. It can be learned that in this embodiment of this application, automatic migration of a computing power task can be implemented. In this way, when computing power task performance is degraded, automatic migration may be performed on the computing power task, thereby improving computing power task performance.

The following specifically describes two cases in which the terminal initiates computing power task migration and the first network side device initiates computing power task migration.

Case 1: The terminal initiates computing power task migration.

That is, optionally, that a first network side device determines a target task on which computing power migration needs to be performed includes:
receiving, by the first network side device, a computing power migration request sent by a first terminal, where the computing power migration request is used to request to perform computing power migration on at least one task; and
determining, as the target task by the first network side device, a task indicated by the computing power migration request.

When a computing power node is down or load exceeds a threshold, computing power task performance is degraded, which indicates that a computing power task executed by the computing power node needs to be migrated to another computing power node. Therefore, when detecting that a computing power node is down or load exceeds a threshold, the first terminal may send the computing power migration request to the first network side device. In this case, the task indicated by the computing power request is the target task on which computing power migration needs to be performed.

In addition, a process in which the first terminal sends the computing power migration request to the first network side device may include:
the first terminal sends the computing power migration request to a second network side device, so that the second network side device forwards the computing power migration request to a third network side device, and the third network side device forwards the computing power migration request to the CSCF.

The second network side device may be an access and mobility management function (AMF), and the third network side device may be a session management function (SMF).

That is, the first terminal may transmit the computing power migration request to the first network side device through the second network side device and the third network side device.

Optionally, the computing power migration request includes at least one of the following A-1 to A-11:
A-1: a type of a computing power task carried on a source computing power node that needs to perform computing power migration;
A-2: a computing power requirement corresponding to the target task;
A-3: a computing power service information description corresponding to the target task;
A-4: computing power service performance or experience request information corresponding to the target task;
A-5: description information of the target task;
A-6: session container information of a network session N1 interface (N1 SM container) corresponding to the target task;
A-7: a protocol data unit (PDU) session identifier corresponding to the target task;
A-8: integrity protection information of a maximum data rate (Integrity Protection Maximum Data Rate) of a terminal corresponding to the target task;
A-9: information about the source computing power node that needs to perform computing power migration;
A-10: data network name (DNN) information corresponding to the target task; or
A-11: network slice selection assistance information (Single Network Slice Selection Assistance Information, S-NSSAI) corresponding to the target task.

For the foregoing A-1, the type of the computing power task carried on the source computing power node that needs to perform computing power migration is a type of a computing power task carried on a computing power node before computing power migration is performed on the target task, and the type of the computing power task is, for example, a computing task or a rendering task.

For the computing power requirement corresponding to the target task in the foregoing A-2, the computing power requirement herein is a computing power required for completing a computing power task, for example, the number XX of floating-point operations, a CPU quantity, or a memory.

For the computing power service information description corresponding to the target task in the foregoing A-3, the computing power service information description herein is corresponding content that describes a computing power task, for example, virtual reality (VR) rendering, augmented reality (AR) image processing, or network data analysis.

For the computing power service performance or the experience request information corresponding to the target task in the foregoing A-4, the computing power service performance or the experience request information herein is used to indicate experience of a user using a computing power task, for example, a bandwidth or a delay.

For the foregoing A-5, the description information of the target task is used to indicate that the target task is a rendering task, a computing task, an analysis service, or the like. That is, the description information of the target task may be used to indicate a task type of the target task.

For the integrity protection information of the maximum data rate of the terminal corresponding to the target task in the foregoing A-8, the “integrity protection information of the maximum data rate” herein is used to enable the terminal to indicate a maximum data rate of user plane integrity protection used for an uplink and a maximum data rate of user plane integrity protection used for a downlink to the network.

For the information about the source computing power node that needs to perform computing power migration in the foregoing A-9, the “information about the source computing power node” herein may be a server address, a DNN name, or the like.

For the foregoing A-10, the DNN information corresponding to the target task is DNN information of a network accessed by a terminal of the target task.

For the foregoing A-11, the S-NSSAI corresponding to the target task is S-NSSAI of the network accessed by the terminal of the target task.

Optionally, that the first network side device executes a procedure of migrating the target task to the target computing power node includes:
sending, by the first network side device, migration information to a second network side device in response to the computing power migration request, where the migration information is used to instruct the second network side device to send a deregistration (deregistration) indication to the first terminal, and the deregistration indication is used to trigger a terminal to initiate network deregistration; and
interacting, by the first network side device, with the first terminal and the second network side device, executing network deregistration of the first terminal on a network slice corresponding to a first source computing power node and network re-registration on a network slice corresponding to the target computing power node, and migrating the target task to the target computing power node, where the first source computing power node is a computing power node before computing power migration is performed on the target task of the first terminal.

It can be learned from this that, in a case that the first terminal initiates computing power migration, after receiving the computing power migration request sent by the first terminal and determining the target computing power node for this computing power migration, the first network side device may send the migration information to the second network side device, so that the second network side device decides to perform computing power migration, and further the second network side device sends the deregistration indication to the first terminal. Therefore, the first terminal initiates the network deregistration procedure, so that the first network side device, the first terminal, and the second network side device interact with each other, to implement the network deregistration and re-registration procedures for the first terminal, and further to migrate the target task from the source computing power node to the target computing power node.

It should be noted herein that the target task is migrated from the first source computing power node to the target computing power node, that is, the first terminal corresponding to the target task completes the network deregistration on the network slice corresponding to the first source computing power node and the network re-registration on the network slice corresponding to the target computing power node. Therefore, after the foregoing step of “executing network deregistration of the first terminal on a network slice corresponding to a first source computing power node and network re-registration on a network slice corresponding to the target computing power node”, the target task is switched to the target computing power node.

Optionally, the migration information includes at least one of the following B-1 to B-5:
B-1: new S-NSSAI for computing power migration;
B-2: old S-NSSAI corresponding to deregistration;
B-3: re-registration indication information;
B-4: DNN information for computing power migration; or
B-5: information about the target computing power node.

After receiving the migration information including at least one of the foregoing B-1 to B-5, the second network side device may decide to perform network deregistration on the first terminal. Further, when the migration information includes the old S-NSSAI, the deregistration indication sent by the second network side device to the first terminal may further carry the old S-NSSAI, to instruct the first terminal to perform network deregistration on the old S-NSSAI.

Optionally, the deregistration indication includes indication information indicating that a reason for this deregistration is computing power migration.

That is, the deregistration indication sent by the second network side device to the first terminal may further indicate that a reason for this network deregistration is “computing power migration”.

Case 2: The first network side device initiates computing power task migration.

That is, optionally, that a first network side device determines a target task on which computing power migration needs to be performed includes:
determining, by the first network side device based on a computing power task and/or a computing power resource usage status of a computing power node, a source computing power node that needs to perform computing power migration, and determining a computing power task carried on the source computing power node as the target task.

It can be learned from this that the computing power task and/or the computing power resource usage status of the computing power node are/is stored in the first network side device. Therefore, the first network side device may monitor, in real time based on the computing power task and/or the computing power resource usage status, whether computing power task performance is degraded for a computing power task of each computing power node. For example, when a resource processing occupation status of a computing power node reaches a threshold or a computing power node fails and cannot continue to provide a service, computing power task performance is degraded. In this case, the first network side device may independently initiate computing power migration on a task carried on the computing power node.

Optionally, the target computing power node includes at least one target node corresponding to a second terminal, and the second terminal includes a terminal corresponding to the target task; and
that the first network side device executes a procedure of migrating the target task to the target computing power node includes:
sending, by the first network side device, migration information to a second network side device, where the migration information is used to instruct the second network side device to send a deregistration indication to each second terminal, and the deregistration indication is used to trigger a terminal to initiate network deregistration; and
interacting, by the first network side device, with each second terminal and the second network side device, executing network deregistration of the second terminal on a network slice corresponding to a second source computing power node and network re-registration on a network slice corresponding to a target node corresponding to the second terminal, and migrating a target task corresponding to the second terminal to the target node corresponding to the second terminal, where the second source computing power node is a computing power node before computing power migration is performed on the target task corresponding to the second terminal.

It can be learned from this that, in a case that the first network side device initiates computing power migration, the first network side device needs to determine a corresponding target computing power node for a terminal (the second terminal) of a task carried on a source node (It can be understood that target computing power nodes of different second terminals may be the same or may be different). Then, the first network side device may send the migration information to the second network side device, so that the second network side device decides to perform computing power migration. Therefore, the second network side device sends the deregistration indication to the second terminal, so that the second terminal initiates the network deregistration procedure, and the first network side device, the second terminal, and the second network side device interact with each other, to implement the network deregistration and re-registration procedures for the second terminal, and further to migrate the target task corresponding to the second terminal to the target computing power node corresponding to the second terminal.

Optionally, the migration information includes at least one of the following B-1 to B-5:
B-1: new S-NSSAI for computing power migration;
B-2: old S-NSSAI corresponding to deregistration;
B-3: re-registration indication information;
B-4: DNN information for computing power migration; or
B-5: information about the target computing power node.

After receiving the migration information including at least one of the foregoing B-1 to B-5, the second network side device may decide to perform network deregistration on the second terminal. Further, when the migration information includes the old S-NSSAI, the deregistration indication sent by the second network side device to the second terminal may further carry the old S-NSSAI, to instruct the second terminal to perform network deregistration on the old S-NSSAI.

Optionally, the deregistration indication includes indication information indicating that a reason for this deregistration is computing power migration.

That is, the deregistration indication sent by the second network side device to the second terminal may further indicate that a reason for this network deregistration is “computing power migration”.

It can be learned from the foregoing case 1 and the case 2 that when initiating computing power migration, the first terminal needs to migrate the target task of the first terminal to the target computing power node; and when initiating computing power migration, the first network side device needs to separately migrate the task corresponding to the second terminal of the task carried on the source computing power node to the target computing power node corresponding to each second terminal.

Optionally, the method further includes:
receiving, by the first network side device, computing power capability information reported by at least one computing power node.

Optionally, that the first network side device determines a target computing power node for the computing power migration of the target task includes:
determining, by the first network side device, the target computing power node based on the computing power capability information.

It can be learned from this that, in this embodiment of this application, each computing power node may report respective computing power capability information to the first network side device in real time, so that the latest computing power capability information can be used when computing power migration is performed. Therefore, the target task may be migrated to a more proper computing power node, thereby further improving computing power task performance.

Optionally, the computing power capability information includes at least one of the following:
C-1: computing power resource usage information;
C-2: load information;
C-3: a computing power node identifier;
C-4: an internet protocol (IP) address of a computing power node;
C-5: overall computing power or capacity information of a computing power node;
C-6: a user identifier of a terminal that is accessed by a computing power node;
C-7: S-NSSAI corresponding to a computing power node;
C-8: DNN information corresponding to a computing power node;
C-9: a PDU session identifier corresponding to a computing power task of a computing power node;
C-10: S-NSSAI of a computing power session of a computing power node; or
C-11: DNN information of a computing power session of a computing power node.

For the foregoing C-1, the computing power resource usage information is used to indicate a usage status of a computing power resource, for example, used to indicate a proportion of used computing power resources to all computing power resources of a computing power node.

For the foregoing C-2, the load information is used to indicate a status of a load carried on a computing power node.

For the user identifier of the terminal that is accessed by the computing power node in the C-6, for example, for an event exposure service of an AMF (Naf_EventExposure_Notify), the user identifier may be a generic public subscription identifier (GPSI) or a subscription permanent identifier (SUPI).

The foregoing C-7 and C-8 are S-NSSAI and DNN that are configured for a computing power node, and the foregoing C-10 and C-11 are S-NSSAI and DNN that are used by a computing power node.

Optionally, the method further includes at least one of the following:
D-1: interacting, by the first network side device, with a source computing power node of the target task to obtain migration computing power session-related information; or
D-2: interacting, by the first network side device, with the target computing power node to perform a migration preparation operation, where
the executing, by the first network side device, a procedure of migrating the target task to the target computing power node includes:
executing, by the first network side device based on the migration computing power session-related information and/or the migration preparation operation, the procedure of migrating the target task to the target computing power node.

It can be learned from this that, regardless of whether the foregoing “case 1 (that is, the terminal initiates computing power migration)” or the foregoing “case 2 (that is, the first network side device initiates computing power migration)”, the first network side device may execute the process of the foregoing D-1 and/or D-2, that is, the migration computing power session-related information may be exchanged, and/or the migration preparation operation may be performed, so that the first network side device performs, based on the migration computing power session-related information and/or the migration preparation operation, the procedure of migrating the target task to the target computing power node.

It can be understood that, the migration computing power session-related information may also be notified to the first network side device during computing power node registration and update.

Optionally, the migration computing power session-related information includes at least one of the following:
a terminal identifier, a protocol data unit session identifier, network slice selection assistance information, or data network name information that are corresponding to the target task.

It should be noted herein that, if the terminal initiates computing power migration, the “terminal identifier” in the “migration computing power session-related information” herein is an identifier of a terminal that initiates a migration request. If the first network side device initiates computing power migration, the “terminal identifier” in the “migration computing power session-related information” herein is an identifier of a terminal of a task of the source computing power node.

Optionally, the migration preparation operation includes at least one of the following:
resource application, computing power node configuration update, computing power service launch, computing power service activation, or computing power service registration.

The “resource application” herein is to apply for a resource for the target task on which computing power migration needs to be performed.

The “computing power node configuration update” is, for example, computing power node expansion or resource reservation.

The “computing power service launch” is deployment of a computing power service by a computing power node and belongs to service opening.

The “computing power service activation” means that a computing power service may be provided externally and belongs to service launch.

The “computing power service registration” is to re-register a computing power service for the target task on which computing power migration needs to be performed.

According to a second aspect, an embodiment of this application provides a computing power task migration method. As shown in FIG. 3, the method may include the following step 301:
Step 301: A first terminal sends a computing power migration request to a first network side device.

The computing power migration request is used to request to perform computing power migration on at least one task, the computing power migration request is further used to trigger the first network side device to determine a target computing power node for computing power migration of a target task, and the target task is a task indicated by the computing power migration request.

The first network side device may be a CSCF, and the first terminal is a terminal corresponding to a task on which computing power migration needs to be performed, that is, a terminal corresponding to the target task.

After a terminal or a network side device initiates a computing power service request, a network allocates a computing power server (or node) that can meet a computing power task requirement to the terminal or the network side device to execute a corresponding computing power task. In some cases (for example, a computing power node is down or a computing power task increases suddenly), computing power task performance may be degraded during execution of the computing power task. For such a computing power task whose performance is degraded, computing power task migration may be performed to migrate the computing power task to a proper computing power node, thereby improving computing power task performance.

It can be learned from this that, in this embodiment of this application, the target task on which computing power migration needs to be performed may be a task whose computing power task performance is degraded. Whether computing power task performance is degraded, that is, whether computing power migration needs to be performed on the computing power task may be monitored and initiated by the terminal.

For example, when a computing power node is down or load exceeds a threshold, computing power task performance is degraded, which indicates that a computing power task executed by the computing power node needs to be migrated to another computing power node. Therefore, when detecting that a computing power node is down or load exceeds a threshold, a terminal may send the computing power migration request to the first network side device. In this case, the task indicated by the computing power request is the target task on which computing power migration needs to be performed.

In addition, a process in which the first terminal sends the computing power migration request to the first network side device may include:
the first terminal sends the computing power migration request to a second network side device, so that the second network side device forwards the computing power migration request to a third network side device, and the third network side device forwards the computing power migration request to the first network side device.

The third network side device may be an SMF.

That is, the first terminal may transmit the computing power migration request to the first network side device through the second network side device and the third network side device.

Optionally, the computing power migration request includes at least one of the following A-1 to A-11:
A-1: a type of a computing power task carried on a source computing power node that needs to perform computing power migration;
A-2: a computing power requirement corresponding to the target task;
A-3: a computing power service information description corresponding to the target task;
A-4: computing power service performance or experience request information corresponding to the target task;
A-5: description information of the target task;
A-6: session container information of a network session N1 interface (N1 SM container) corresponding to the target task;
A-7: a protocol data unit (PDU) session identifier corresponding to the target task;
A-8: integrity protection information of a maximum data rate (Integrity Protection Maximum Data Rate) of a terminal corresponding to the target task;
A-9: information about the source computing power node that needs to perform computing power migration;
A-10: data network name (DNN) information corresponding to the target task; or
A-11: network slice selection assistance information (Single Network Slice Selection Assistance Information, S-NSSAI) corresponding to the target task.

For related explanations of the foregoing A-1 to A-11, refer to the foregoing descriptions. Details are not described herein again.

Optionally, the method further includes:
receiving, by the first terminal, a deregistration indication sent by a second network side device, where the deregistration indication is sent after the second network side device receives migration information sent by the first network side device, and the deregistration indication is used to trigger a terminal to initiate network deregistration; and
interacting, by the first terminal, with the first network side device and the second network side device, executing network deregistration of the first terminal on a network slice corresponding to a first source computing power node and network re-registration on a network slice corresponding to the target computing power node, and migrating the target task to the target computing power node, where the first source computing power node is a computing power node before computing power migration is performed on the target task of the first terminal.

The second network side device may be an AMF.

It can be learned from this that, in a case that the first terminal initiates computing power migration, after receiving the computing power migration request sent by the terminal and determining the target computing power node for this computing power migration, the first network side device may send the migration information to the second network side device, so that the second network side device decides to perform computing power migration, and further the second network side device sends the deregistration indication to the terminal. Therefore, the terminal initiates the network deregistration procedure, so that the first network side device, the first terminal, and the second network side device interact with each other, to implement the network deregistration and re-registration procedures for the first terminal, and further to migrate the target task from the source computing power node to the target computing power node corresponding to the terminal.

It should be noted herein that the target task is migrated from the first source computing power node to the target computing power node, that is, the first terminal corresponding to the target task completes the network deregistration on the network slice corresponding to the first source computing power node and the network re-registration on the network slice corresponding to the target computing power node. Therefore, after the foregoing step of “executing network deregistration of the first terminal on a network slice corresponding to a first source computing power node and network re-registration on a network slice corresponding to the target computing power node”, the target task is switched to the target computing power node.

Optionally, the migration information includes at least one of the following B-1 to B-5:
B-1: new S-NSSAI for computing power migration;
B-2: old S-NSSAI corresponding to deregistration;
B-3: re-registration indication information;
B-4: DNN information for computing power migration; or
B-5: information about the target computing power node.

After receiving the migration information including at least one of the foregoing B-1 to B-5, the second network side device may decide to perform network deregistration on the first terminal. Further, when the migration information includes the old S-NSSAI, the deregistration indication sent by the second network side device to the first terminal may further carry the old S-NSSAI, to instruct the first terminal to perform network deregistration on the old S-NSSAI.

Optionally, the deregistration indication includes indication information indicating that a reason for this deregistration is computing power migration.

That is, the deregistration indication sent by the second network side device to the first terminal may further indicate that a reason for this network deregistration is “computing power migration”.

Optionally, the method further includes:
interacting, by the first terminal, with the second network side device, and updating a user configuration of the first terminal.

After receiving the migration information, the second network side device may further update the user configuration of the terminal based on the migration information, so that the terminal can smoothly perform computing power migration.

Optionally, the updated user configuration of the first terminal includes at least one of the following E-1 to E-6:
E-1: allowed network slice selection assistance information (Allowed NSSAI);
E-2: a correspondence between allowed NSSAI and subscribed network slice selection assistance information (Subscribed NSSAI);
E-3: a correspondence between allowed NSSAI and configured network slice selection assistance information (Configured NSSAI);
E-4: a data network name;
E-5: a terminal configuration policy; or
E-6: a terminal route selection policy.

In the “Allowed NSSAI” in the foregoing E-1 is a set of identifiers of network slice s that are allowed to be accessed by a network.

In the “correspondence between allowed NSSAI and subscribed NSSAI” in the foregoing E-2, if allowed NSSAI corresponds to subscribed NSSAI, it indicates that the allowed NSSAI serves the subscribed NSSAI.

In the “correspondence between allowed NSSAI and configured NSSAI” in the foregoing E-3, if allowed NSSAI corresponds to configured NSSAI, it indicates that the allowed NSSAI serves the configured NSSAI.

In the terminal route selection policy in the foregoing E-6, for example, a computing power application initiates a PDU session request to carry new S-NSSAI, where a new DNN in the URSP corresponds to the new S-NSSAI, or a computing power application APP corresponds to the new S-NSSAI.

In a UE configuration update (UCU) notification, the second network side device may perform re-registration after notifying the terminal of UCU. Optionally, the notification may carry a re-registration reason: computing power migration.

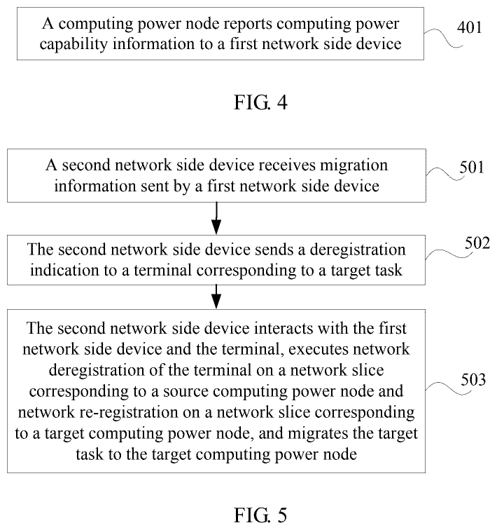

According to a third aspect, an embodiment of this application provides a computing power task migration method. As shown in FIG. 4, the method may include the following step 401:
Step 401: A computing power node reports computing power capability information to a first network side device.

It can be learned from this that each computing power node may report respective computing power capability information to the first network side device. The computing power node periodically reports the respective computing power capability information to the first network side device. In this way, the first network side device stores the computing power capability information reported by each computing power node in real time. Therefore, when computing power migration needs to be performed on a computing power task, the first network side device may select, based on the stored computing power capability information of each computing power node, a proper target computing power node for the computing power task on which computing power migration needs to be performed.

That is, the computing power capability information is a basis for determining the target computing power node for the computing power task on which computing power migration needs to be performed.

It should be noted herein that after a terminal or a network side device initiates a computing power service request, a network allocates a computing power server (or node) that can meet a computing power task requirement to the terminal or the network side device to execute a corresponding computing power task. In some cases (for example, a computing power node is down or a computing power task increases suddenly), computing power task performance may be degraded during execution of the computing power task. For such a computing power task whose performance is degraded, computing power task migration may be performed to migrate the computing power task to a proper computing power node, thereby improving computing power task performance.

It can be learned from this that, in this embodiment of this application, the target task on which computing power migration needs to be performed may be a task whose computing power task performance is degraded. Whether computing power task performance is degraded, that is, whether computing power migration needs to be performed on the computing power task may be monitored and initiated by the terminal, or may be monitored and initiated by the first network side device (for example, a CSCF).

In addition, the first network side device may be a CSCF.

Optionally, the computing power capability information includes at least one of the following:
C-1: computing power resource usage information;
C-2: load information;
C-3: a computing power node identifier;
C-4: an internet protocol (IP) address of a computing power node;
C-5: overall computing power or capacity information of a computing power node;
C-6: a user identifier of a terminal that is accessed by a computing power node;
C-7: S-NSSAI corresponding to a computing power node;
C-8: DNN information corresponding to a computing power node;
C-9: a PDU session identifier corresponding to a computing power task of a computing power node;
C-10: S-NSSAI of a computing power session of a computing power node; or
C-11: DNN information of a computing power session of a computing power node.

For related explanations of the foregoing C-1 to C-11, refer to the foregoing descriptions. Details are not described herein again.

Optionally, the method further includes at least one of the following:
interacting, by the computing power node, with the first network side device, and sending migration computing power session-related information to the first network side device; or
interacting, by the computing power node, with the first network side device to perform a migration preparation operation.

When a computing power node serves as a source computing power node that needs to perform computing power migration, in a computing power migration process, the computing power node may interact with the first network side device, to provide the migration computing power session-related information to the first network side device. When a computing power node serves as a target computing power node for computing power migration, in a computing power migration process, the computing power node may interact with the first network side device to perform the migration preparation operation.

It can be understood that, the migration computing power session-related information may also be notified to the first network side device during computing power node registration and update.

Optionally, the migration computing power session-related information includes at least one of the following:
a terminal identifier, a protocol data unit session identifier, network slice selection assistance information, or data network name information that are corresponding to a target task, where
the target task is a task on which computing power migration needs to be performed.

It should be noted herein that, if the terminal initiates computing power migration, the “terminal identifier” in the “migration computing power session-related information” herein is an identifier of a terminal that initiates a migration request. If the first network side device initiates computing power migration, the “terminal identifier” in the “migration computing power session-related information” herein is an identifier of a terminal of a task of the source computing power node.

Optionally, the migration preparation operation includes at least one of the following:
resource application, computing power node configuration update, computing power service launch, computing power service activation, or computing power service registration.

According to a fourth aspect, an embodiment of this application provides a computing power task migration method. As shown in FIG. 5, the method may include the following steps 501 to 503:
Step 501: A second network side device receives migration information sent by a first network side device.

Step 502: The second network side device sends a deregistration indication to a terminal corresponding to a target task.

The deregistration indication is used to trigger the terminal to initiate network deregistration, and the target task is a computing power task on which computing power migration needs to be performed.

Step 503: The second network side device interacts with the first network side device and the terminal, executes network deregistration of the terminal on a network slice corresponding to a source computing power node and network re-registration on a network slice corresponding to a target computing power node, and migrates the target task to the target computing power node.

The source computing power node is a computing power node before computing power migration is performed on the target task of the terminal, and the target computing power node is a computing power node after computing power migration is performed on the target task of the terminal.

In addition, the first network side device may be a CSCF, the second network side device may be an AMF, and the terminal is a terminal corresponding to the task on which computing power migration needs to be performed.

After a terminal or a network side device initiates a computing power service request, a network allocates a computing power server (or node) that can meet a computing power task requirement to the terminal or the network side device to execute a corresponding computing power task. In some cases (for example, a computing power node is down or a computing power task increases suddenly), computing power task performance may be degraded during execution of the computing power task. For such a computing power task whose performance is degraded, computing power task migration may be performed to migrate the computing power task to a proper computing power node, thereby improving computing power task performance.

It can be learned from this that, in this embodiment of this application, the target task on which computing power migration needs to be performed may be a task whose computing power task performance is degraded. Whether computing power task performance is degraded, that is, whether computing power migration needs to be performed on the computing power task may be monitored and initiated by the terminal, or may be monitored and initiated by the first network side device (for example, a CSCF).

When computing power migration is initiated by the terminal, the terminal in step 502 is the terminal that initiates computing power migration. When computing power migration is initiated by the first network side device, the terminal in step 502 is one of terminals of tasks carried on the source computing power node that needs to perform computing power migration.

It can be learned from the foregoing steps 501 to 503 that, when the first network side device determines that computing power migration needs to be performed on the target task, the first network side device may send the migration information to the second network side device, so that the second network side device decides to perform computing power migration. Further, the second network side device sends the deregistration indication to the terminal, so that the terminal initiates the network deregistration procedure, and the first network side device, the terminal, and the second network side device interact with each other to implement the network deregistration and re-registration procedures for the terminal, thereby migrating the target task from the source computing power node to the target computing power node corresponding to the terminal.

Optionally, the migration information includes at least one of the following B-1 to B-5:
B-1: new S-NSSAI for computing power migration;
B-2: old S-NSSAI corresponding to deregistration;
B-3: re-registration indication information;
B-4: DNN information for computing power migration; or
B-5: information about the target computing power node.

After receiving the migration information including at least one of the foregoing B-1 to B-5, the second network side device may decide to perform network deregistration on the first terminal. Further, when the migration information includes the old S-NSSAI, the deregistration indication sent by the second network side device to the first terminal may further carry the old S-NSSAI, to instruct the first terminal to perform network deregistration on the old S-NSSAI.

Optionally, the deregistration indication includes indication information indicating that a reason for this deregistration is computing power migration.

That is, the deregistration indication sent by the second network side device to the first terminal may further indicate that a reason for this network deregistration is “computing power migration”.

Optionally, the method further includes:
interacting, by the second network side device, with the terminal based on the migration information, and updating a user configuration of the terminal.

After receiving the migration information, the second network side device may further update the user configuration of the terminal based on the migration information, so that the terminal can smoothly perform computing power migration.

Optionally, the updated user configuration of the terminal includes at least one of the following E-1 to E-6:
E-1: allowed network slice selection assistance information (Allowed NSSAI);
E-2: a correspondence between allowed NSSAI and subscribed network slice selection assistance information (Subscribed NSSAI);
E-3: a correspondence between allowed NSSAI and configured network slice selection assistance information (Configured NSSAI);
E-4: a data network name;
E-5: a terminal configuration policy; or
E-6: a terminal route selection policy.

For related explanations of the foregoing E-1 to E-6, refer to the foregoing descriptions. Details are not described herein again.

Optionally, the method further includes:
receiving, by the second network side device, a computing power migration request sent by the terminal; and
forwarding, by the second network side device, the computing power migration request to the first network side device, where
the computing power migration request is used to request to perform computing power migration on at least one task, the computing power migration request is further used to trigger the first network side device to determine the target computing power node, and the target task is a task indicated by the computing power migration request.

It can be learned from this that when the terminal detects that computing power migration needs to be performed, the terminal may send the computing power migration request to the second network side device, so that the second network side device forwards the computing power migration request to the first network side device.

Further, a process in which the second network side device forwards the computing power migration request to the first network side device may be specifically: the second network side device forwards the computing power migration request to a third network side device, so that the third network side device forwards the computing power migration request to the first network side device. The third network side device may be an SMF.

It can be learned from the foregoing that the terminal may transmit the computing power migration request to the first network side device through the second network side device and the third network side device.

Optionally, the computing power migration request includes at least one of the following A-1 to A-11:
A-1: a type of a computing power task carried on a source computing power node that needs to perform computing power migration;
A-2: a computing power requirement corresponding to the target task;
A-3: a computing power service information description corresponding to the target task;
A-4: computing power service performance or experience request information corresponding to the target task;
A-5: description information of the target task;
A-6: session container information of a network session N1 interface (N1 SM container) corresponding to the target task;
A-7: a protocol data unit (PDU) session identifier corresponding to the target task;
A-8: integrity protection information of a maximum data rate (Integrity Protection Maximum Data Rate) of a terminal corresponding to the target task;
A-9: information about the source computing power node that needs to perform computing power migration;
A-10: data network name (DNN) information corresponding to the target task; or
A-11: network slice selection assistance information (Single Network Slice Selection Assistance Information, S-NSSAI) corresponding to the target task.

For related explanations of the foregoing A-1 to A-11, refer to the foregoing descriptions. Details are not described herein again.

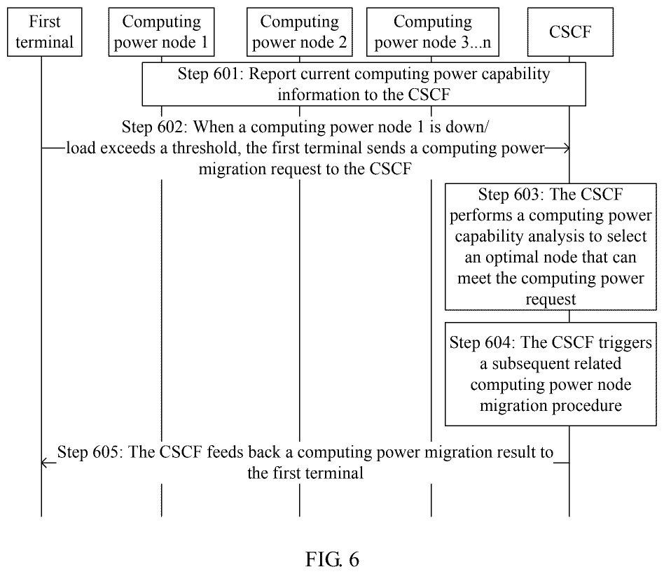

In conclusion, specific implementations of the computing power task migration method in this embodiment of this application may be any one of the following implementations 1 to 4:
Implementation 1: A computing power user (a terminal) triggers computing power migration. As shown in FIG. 6, specific steps 601 to 605 are described below.

Step 601: Different computing power nodes may report computing power capability information to a CSCF in real time.

The reported computing power capability information includes at least one of the following:
computing power resource usage information;
load information;
a computing power node identifier;
an internet protocol address (Internet Protocol, IP) address of a computing power node;
overall computing power or capacity information of a computing power node;
a user identifier (UE ID) of a terminal that is accessed by a computing power node (for an event exposure service of an AMF (Naf_EventExposure_Notify), the user identifier may be a generic public subscription identifier (GPSI) or a subscription permanent identifier (SUPI));
network slice selection assistance information (Single Network Slice Selection Assistance Information, S-NSSAI) corresponding to a computing power node;
data network name (DNN) information corresponding to a computing power node;
a protocol data unit (PDU) session identifier corresponding to a computing power task of a computing power node;
S-NSSAI of a computing power session of a computing power node (for example, S-NSSAI corresponding to an application function (AF)); or
DNN information of a computing power session of a computing power node (for example, DNN information corresponding to an AF).

Step 602: When a computing power node 1 (a computing power node connected to a first terminal) is down or load exceeds a threshold, and computing power task performance is degraded, the first terminal sends a computing power migration request to the CSCF, to request to perform computing power migration on a target task being processed by the first terminal.

The computing power migration request includes at least one of the following:
a type of a computing power task carried on a source computing power node of the target task;
a computing power requirement corresponding to the target task;
a computing power service information description corresponding to the target task;
computing power service performance or experience request information corresponding to the target task;
description information of the target task;
session container information of a network session N1 interface (N1 SM container) corresponding to the target task;
a PDU session identifier corresponding to the target task;
an integrity protection maximum data rate (Integrity Protection Maximum Data Rate) of a terminal corresponding to the target task;
information about the source computing power node (the computing power node 1) of the target task;
DNN information corresponding to the target task; or
S-NSSAI corresponding to the target task.

Step 603: The CSCF performs a computing power capability analysis to select an optimal node that can meet the foregoing computing power request.

The CSCF stores capability information of the foregoing computing power node. Therefore, the CSCF may determine, based on the capability information of the computing power node and the related information in the migration request, an optimal computing power node to perform computing power migration.

Optionally, the optimal node may be selected by the CSCF itself.

Optionally, a network data analytics function (NWDAF) may obtain the capability information of the foregoing computing power node and the information in the migration request, to determine an optimal computing power node to perform computing power migration, and feed back the node to the CSCF.

For example, the CSCF determines that computing power migration is performed to a computing power node 2.

Further, the CSCF may also determine corresponding migrated new S-NSSAI and/or DNN.

Step 604: The CSCF triggers a subsequent related computing power node migration procedure.

The computing power node migration procedure includes deregistration and re-registration. That is, the CSCF may perform deregistration on the first terminal in the computing power node 1 based on one or more of the UE ID uploaded by the computing power node, the S-NSSAI corresponding to the computing power node, and the DNN information corresponding to the computing power node; and then re-register the first terminal with a network corresponding to the new computing power node 2.

Step 605: The CSCF feeds back a computing power migration result to the first terminal.

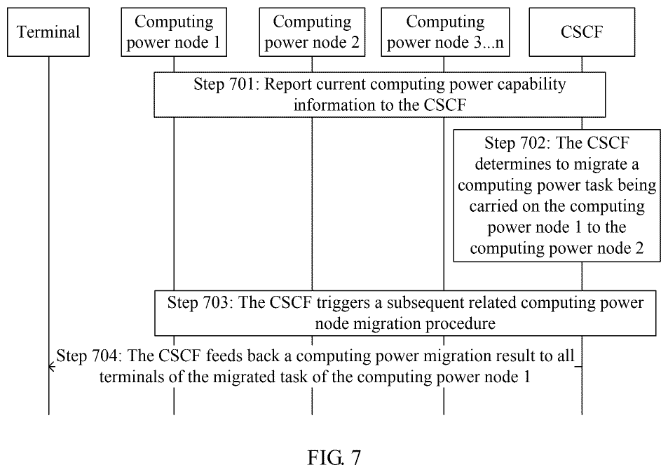

Implementation 2: A CSCF independently triggers computing power migration. As shown in FIG. 7, specific steps 701 to 705 are described below.

Step 701: Different computing power nodes may report computing power capability information to a CSCF in real time.

The reported computing power capability information includes at least one of the following:
computing power resource usage information;
load information;
a computing power node identifier;
an IP address of a computing power node;
overall computing power or capacity information of a computing power node;
a UE ID of a terminal that is accessed by a computing power node (for Naf_EventExposure_Notify, the UE ID may be a GPSI or an SUPI);
S-NSSAI corresponding to a computing power node;
DNN information corresponding to a computing power node;
a PDU session identifier corresponding to a computing power task of a computing power node;
S-NSSAI of a computing power session of a computing power node (for example, S-NSSAI corresponding to an AF); or
DNN information of a computing power session of a computing power node (for example, DNN information corresponding to an AF).

Step 702: The CSCF determines to migrate a computing power task being carried on a computing power node 1 to a computing power node 2.

That is, the CSCF monitors a computing power task and/or a computing power resource usage status of a computing power node. When a resource processing occupation status of the computing power node 1 reaches a threshold or the computing power node 1 fails to continue to provide a service, the CSCF determines that the computing power node 1 cannot carry the computing power task, and the CSCF controls the computing power node to migrate the computing power task that is being carried to another computing power node.

The CSCF stores capability information of the foregoing computing power node. Therefore, the CSCF may determine, based on the capability information of the computing power node, an optimal computing power node to perform computing power migration.

Optionally, the optimal node may be selected by the CSCF itself.

Optionally, a network data analytics function (NWDAF) may obtain the capability information of the foregoing computing power node, to determine an optimal computing power node to perform computing power migration, and feed back the node to the CSCF.

Further, the CSCF may also determine corresponding migrated new S-NSSAI and/or DNN.

Step 703: The CSCF triggers a subsequent related computing power node migration procedure.

The computing power node migration procedure includes deregistration and re-registration. That is, the CSCF may perform, based on one or more of the UE ID uploaded by the computing power node, the S-NSSAI corresponding to the computing power node, and the DNN information corresponding to the computing power node, deregistration on a terminal of the migrated task of the computing power node 1, and then re-register these terminals with a network corresponding to the new computing power node 2.

Step 704: The CSCF feeds back a computing power migration result to a terminal of the migrated task of the computing power node 1.

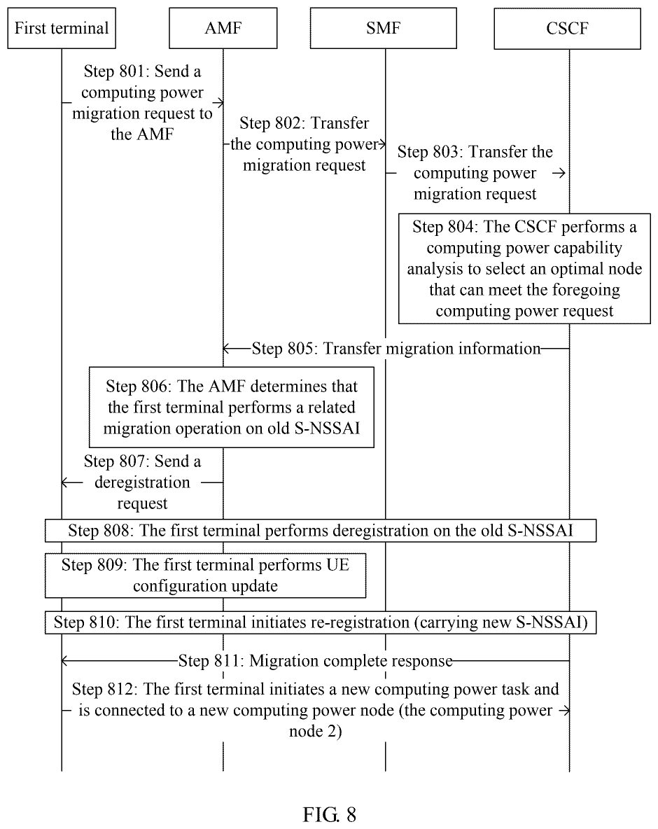

Implementation 3: A computing power user (a terminal) triggers computing power migration (that is, this implementation 3 is a further refined procedure of the foregoing implementation 1). As shown in FIG. 8, the following steps 801 to 811 are included:
Step 801: When discovering that performance of a computing power service is degraded (for example, a computing power node 1 accessed by a first terminal is down or load exceeds a threshold), the first terminal sends a computing power migration request to an AMF, to request to perform computing power migration on a target task being processed by the first terminal.

The computing power migration request includes at least one of the following:
a type of a computing power task carried on a source computing power node that needs to perform computing power migration;
a computing power requirement corresponding to the target task;
a computing power service information description corresponding to the target task;
computing power service performance or experience request information corresponding to the target task;
description information of the target task;
network session N1 SM container information corresponding to the target task;
a PDU session identifier corresponding to the target task;
an integrity protection maximum data rate of a terminal corresponding to the target task;
information about the source computing power node (the computing power node 1) that needs to perform computing power migration;
DNN information corresponding to the target task; or
S-NSSAI corresponding to the target task.

Step 802: The AMF transfers the migration request to an SMF.

Step 803: The SMF transfers the migration request to a CSCF.

Step 804: The CSCF performs a computing power capability analysis to select an optimal node that can meet the foregoing computing power request.

The CSCF stores capability information of the foregoing computing power node. Therefore, the CSCF may determine, based on the capability information of the computing power node and the related information in the migration request, an optimal computing power node to perform computing power migration.

Optionally, the optimal node may be selected by the CSCF itself.

Optionally, a network data analytics function (NWDAF) may obtain the capability information of the foregoing computing power node and the information in the migration request, to determine an optimal computing power node to perform computing power migration, and feed back the node to the CSCF.

For example, the CSCF determines that computing power migration is performed to a computing power node 2.

Further, the CSCF may also determine corresponding migrated new S-NSSAI and/or DNN.

Step 805: The CSCF transfers migration information to the AMF.

The migration information includes at least one of the following:
new S-NSSAI for computing power migration;
old S-NSSAI corresponding to deregistration;
re-registration indication information;
new DNN information for computing power migration; or
information about the computing power node 2.

Step 806: After receiving the migration information, the AMF determines that the first terminal performs a related migration operation on the old S-NSSAI.

Step 807: The AMF sends a deregistration request (carrying the old S-NSSAI) to the first terminal. Optionally, the request carries a deregistration reason: computing power migration.

Step 808: The first terminal performs deregistration on the old S-NSSAI.

Step 809: The AMF initiates a UE configuration update procedure based on the migration information transferred by the CSCF.

The updated content includes at least one of the following:
allowed network slice selection assistance information (Allowed NSSAI);
a correspondence between allowed NSSAI and subscribed (Subscribed) NSSAI;
a correspondence between allowed NSSAI and configuration (Configuration) NSSAI;
a DNN;
a UE configuration policy (Policy); or
a UE route selection policy (URSP).

The UE route selection policy is, for example, that a computing power application initiates a PDU session request to carry new S-NSSAI, where a new DNN in the URSP corresponds to the new S-NSSAI, or a computing power application APP corresponds to the new S-NSSAI.

In addition, in a UE configuration update (UCU) notification, the AMF may perform re-registration after notifying the terminal of UCU. Optionally, the notification may carry a re-registration reason: computing power migration.

Step 810: The first terminal initiates re-registration (carrying the new S-NSSAI).

Step 811: The CSCF sends a migration complete response to the first terminal.

Step 812: The first terminal initiates a new computing power task and is connected to a new computing power node (the computing power node 2).

Thereafter, the source computing power node (the computing power node 1) and

the target computing power node (the computing power node 2) perform computing power registration and/or computing power update in the CSCF, and the migration is completed.

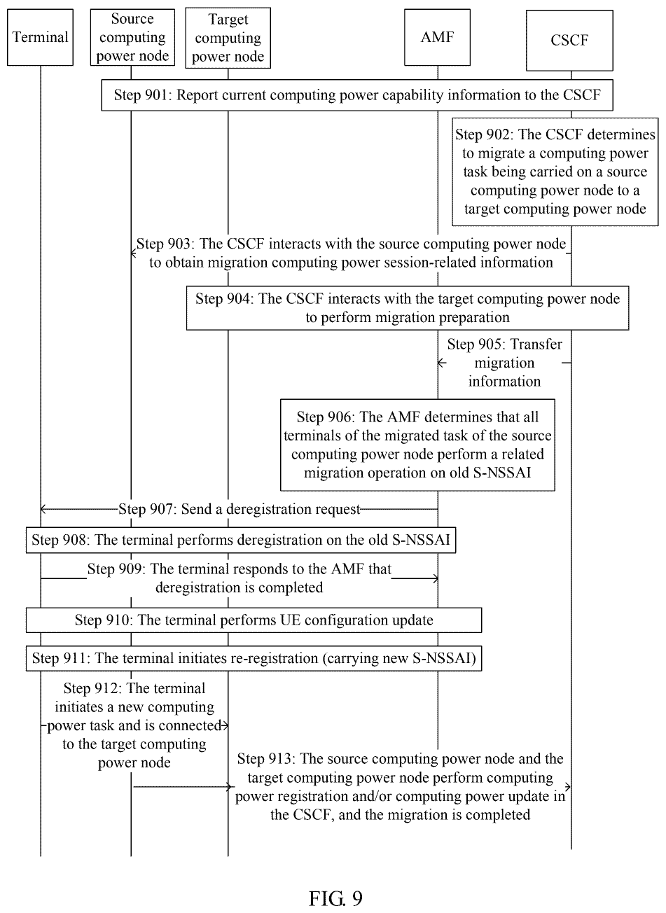

Implementation 4: A CSCF independently triggers computing power migration (that is, the implementation 4 is a further refined procedure of the foregoing implementation 2). As shown in FIG. 9, the following steps 901 to 911 are included:
Step 901: Different computing power nodes may report computing power capability information to a CSCF in real time.

The reported computing power capability information includes at least one of the following:
computing power resource usage information;
load information;
a computing power node identifier;
an IP address of a computing power node;
overall computing power or capacity information of a computing power node;
a UE ID of a terminal that is accessed by a computing power node (for Naf_EventExposure_Notify, the UE ID may be a GPSI or an SUPI);
S-NSSAI corresponding to a computing power node;
DNN information corresponding to a computing power node;
a PDU session identifier corresponding to a computing power task of a computing power node;
S-NSSAI of a computing power session of a computing power node (for example, S-NSSAI corresponding to an AF); or
DNN information of a computing power session of a computing power node (for example, DNN information corresponding to an AF).

Step 902: The CSCF determines to migrate a computing power task being carried on a source computing power node (a computing power node 1) to a target computing power node (a computing power node 2).

That is, the CSCF monitors a computing power task and/or a computing power resource usage status of a computing power node. When a resource processing occupation status of the computing power node 1 reaches a threshold or the computing power node 1 fails to continue to provide a service, the CSCF determines that the computing power node 1 cannot carry the computing power task, and the CSCF controls the computing power node to migrate the computing power task that is being carried to another computing power node.

The CSCF stores capability information of the foregoing computing power node. Therefore, the CSCF may determine, based on the capability information of the computing power node, an optimal computing power node to perform computing power migration.

Optionally, the optimal node may be selected by the CSCF itself.

Optionally, a network data analytics function (NWDAF) may obtain the capability information of the foregoing computing power node, to determine an optimal computing power node to perform computing power migration, and feed back the node to the CSCF.

Further, the CSCF may also determine corresponding migrated new S-NSSAI and/or DNN.

Step 903: Optionally, the CSCF interacts with the source computing power node (the computing power node 1) to obtain migration computing power session-related information.

The migration computing power session-related information includes at least one of the following:
a UE ID, a PDU session ID, S-NSSAI, DNN, or the like of the terminal of the task carried on the computing power node 1.

In addition, the migration computing power session-related information in this step may also be notified to the CSCF during computing power node registration and update.

Step 904: Optionally, the CSCF interacts with the target computing power node (the computing power node 2) to perform a migration preparation operation, such as resource application, computing power node configuration update, computing power service launch, computing power service activation, and computing power service registration.

Step 905: The CSCF transfers migration information to the AMF.

The migration information includes at least one of the following:
new S-NSSAI for computing power migration;
old S-NSSAI corresponding to deregistration;
re-registration indication information;
new DNN information for computing power migration; or
information about the computing power node 2.

Step 906: After receiving the migration information, the AMF determines that a terminal of the migrated task of the source computing power node performs a related migration operation on the old S-NSSAI.

Step 907: The AMF sends a deregistration request (carrying the old S-NSSAI) to the terminal of the task being carried on the computing power node 1. Optionally, the request carries a deregistration reason: computing power migration.

Step 908: The terminal performs deregistration on the old S-NSSAI.

Step 909: The terminal responds to the AMF that deregistration is completed.

Step 910: The AMF initiates a UE configuration update (UE Configuration Update, UCU) procedure based on the migration information transferred by the CSCF.

The updated content includes at least one of the following:
allowed NSSAI;
a correspondence between allowed NSSAI and subscribed (Subscribed) NSSAI;
a correspondence between allowed NSSAI and configuration (Configuration) NSSAI;
a DNN;
a UE configuration policy (Policy); or
a UE route selection policy (URSP).

The UE route selection policy is, for example, that a computing power application initiates a PDU session request to carry new S-NSSAI, where a new DNN in the URSP corresponds to the new S-NSSAI, or a computing power application APP corresponds to the new S-NSSAI.

In addition, in a UCU notification, the AMF may perform re-registration after notifying the terminal of UCU. Optionally, the notification may carry a re-registration reason: computing power migration.

Step 911: The terminal initiates re-registration (carrying the new S-NSSAI).

Step 912: The terminal initiates a new computing power task and is connected to the target computing power node (the computing power node 2).

Step 913: The source computing power node (the computing power node 1) and the target computing power node (the computing power node 2) perform computing power registration and/or computing power update in the CSCF, and the migration is completed.

It can be learned from the foregoing that, in the foregoing implementation 1 and implementation 3, when the terminal initiates computing power migration, the terminal may be migrated to another computing power node. When the CSCF independently initiates computing power migration, the terminal of the computing power task carried on the source computing power node may be migrated to another computing power node.

An application server is based on a computing power node, and there are the following two possibilities for migration when the computing power node fails:
(1) A network session changes and a registration status remains unchanged.
(2) If a network registration status changes, an existing terminal needs to access a new network and initiate a new computing power service.

In this embodiment of this application, based on the foregoing (2) of computing power node migration, the CSCF collects computing power capability information of different computing power nodes, and a computing power migration decision analysis capability is assigned to the CSCF. Finally, the target computing power node for migration and corresponding network control are determined.

In addition, in an existing 5G network architecture, a network registration status modification condition triggered by a computing power network node is not considered. Network deregistration may be initiated due to a subscription change, a mobility change, or the like. In addition, the UE policy may only trigger UE configuration update (UCU) by means of UDM subscription change. In this embodiment of this application, computing power task migration may be triggered by a network side device, to trigger network deregistration and a UCU procedure.

In addition, in the prior art, a terminal and a network are aware of a session performance change of a computing power task, but do not perceive a computing power task and a computing power requirement, and do not have the capability of triggering a corresponding node sensing request to adjust corresponding computing power task performance. In this embodiment of this application, the terminal or the network side device may monitor a computing power task and a computing power requirement, so that when computing power migration needs to be performed, the computing power task is migrated to a proper computing power node.

The computing power task migration method provided in the embodiments of this application may be executed by a computing power task migration apparatus. In the embodiments of this application, an example in which the computing power task migration apparatus executes the computing power task migration method is used to describe the computing power task migration apparatus provided in the embodiments of this application.

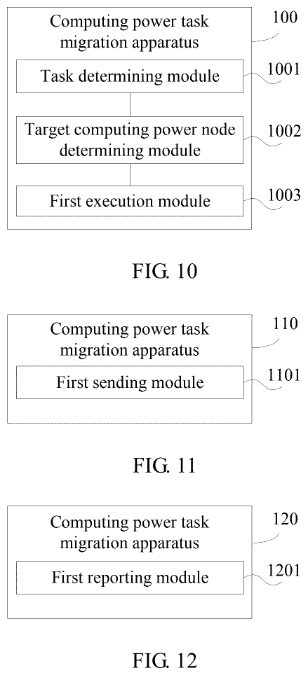

According to a fifth aspect, an embodiment of this application provides a computing power task migration apparatus, which may be applied to a first network side device. The first network side device may be, for example, a CSCF. As shown in FIG. 10, the computing power task migration apparatus 100 may include the following modules:
a task determining module 1001, configured to determine a target task on which computing power migration needs to be performed;
a target computing power node determining module 1002, configured to determine a target computing power node for the computing power migration of the target task; and
a first execution module 1003, configured to execute a procedure of migrating the target task to the target computing power node.

Optionally, the task determining module 1001 is specifically configured to:
receive a computing power migration request sent by a first terminal, where the computing power migration request is used to request to perform computing power migration on at least one task; and
determine, as the target task, a task indicated by the computing power migration request.

Optionally, the task determining module 1001 is specifically configured to:
determine, based on a computing power task and/or a computing power resource usage status of a computing power node, a source computing power node that needs to perform computing power migration, and determine a computing power task carried on the source computing power node as the target task.

Optionally, the computing power migration request includes at least one of the following:
a type of the computing power task carried on the source computing power node that needs to perform computing power migration;
a computing power requirement corresponding to the target task;
a computing power service information description corresponding to the target task;
computing power service performance or experience request information corresponding to the target task;
description information of the target task;
session container information of a network session N1 interface corresponding to the target task;
a protocol data unit session identifier corresponding to the target task;
integrity protection information of a maximum data rate of a terminal corresponding to the target task;
information about the source computing power node that needs to perform computing power migration;
data network name information corresponding to the target task; or network slice selection assistance information corresponding to the target task.

Optionally, the apparatus further includes:
a first receiving module, configured to receive computing power capability information reported by at least one computing power node.

Optionally, the target computing power node determining module 1002 is specifically configured to:
determine the target computing power node based on the computing power capability information.

Optionally, the computing power capability information includes at least one of the following:
computing power resource usage information;
load information;
a computing power node identifier;
an internet protocol address of a computing power node;
overall computing power or capacity information of a computing power node;
a user identifier of a terminal that is accessed by a computing power node;
network slice selection assistance information corresponding to a computing power node;
data network name information corresponding to a computing power node;
a protocol data unit session identifier corresponding to a computing power task of a computing power node;
network slice selection assistance information of a computing power session of a computing power node; or
data network name information of a computing power session of a computing power node.

Optionally, the first execution module 1003 is specifically configured to:
send migration information to a second network side device in response to the computing power migration request received by the task determining module 1001, where the migration information is used to instruct the second network side device to send a deregistration indication to the first terminal, and the deregistration indication is used to trigger a terminal to initiate network deregistration; and
interact with the first terminal and the second network side device, execute network deregistration of the first terminal on a network slice corresponding to a first source computing power node and network re-registration on a network slice corresponding to the target computing power node, and migrate the target task to the target computing power node, where the first source computing power node is a computing power node before computing power migration is performed on the target task of the first terminal.

Optionally, the target computing power node includes at least one target node corresponding to a second terminal, and the second terminal includes a terminal corresponding to the target task; and the first execution module 1003 is specifically configured to:
send migration information to a second network side device, where the migration information is used to instruct the second network side device to send a deregistration indication to each second terminal, and the deregistration indication is used to trigger a terminal to initiate network deregistration; and interact with each second terminal and the second network side device, execute network deregistration of the second terminal on a network slice corresponding to a second source computing power node and network re-registration on a network slice corresponding to a target node corresponding to the second terminal, and migrate a target task corresponding to the second terminal to the target node corresponding to the second terminal, where the second source computing power node is a computing power node before computing power migration is performed on the target task corresponding to the second terminal.

Optionally, the migration information includes at least one of the following: new network slice selection assistance information for computing power migration;
old network slice selection assistance information corresponding to deregistration;
re-registration indication information;
new data network name information for computing power migration; or
information about the target computing power node.

Optionally, the deregistration indication includes indication information indicating that a reason for this deregistration is computing power migration.

Optionally, the apparatus further includes at least one of the following modules: a first information interaction module, configured to interact with a source computing power node of the target task to obtain migration computing power session-related information; or
a first preparation module, configured to interact with the target computing power node to perform a migration preparation operation, where
the first execution module 1003 is specifically configured to:
execute, based on the migration computing power session-related information and/or the migration preparation operation, the procedure of migrating the target task to the target computing power node.

Optionally, the migration computing power session-related information includes at least one of the following:
a terminal identifier, a protocol data unit session identifier, network slice selection assistance information, or data network name information that are corresponding to the target task.

Optionally, the migration preparation operation includes at least one of the following:
resource application, computing power node configuration update, computing power service launch, computing power service activation, or computing power service registration.

The computing power task migration apparatus in this embodiment of this application may be an electronic device, for example, an electronic device with an operating system, or may be a component in the electronic device, for example, an integrated circuit or a chip. The electronic device may be a network side device. For example, the network side device may include but is not limited to the type of the network side device 12 listed above.

The computing power task migration apparatus provided in this embodiment of this application can implement the processes implemented in the method embodiment of FIG. 2, and achieve a same technical effect. To avoid repetition, details are not described herein again.

According to a sixth aspect, an embodiment of this application provides a computing power task migration apparatus, which may be applied to a terminal. As shown in FIG. 11, the computing power task migration apparatus 110 may include the following module:
a first sending module 1101, configured to send a computing power migration request to a first network side device, where the computing power migration request is used to request to perform computing power migration on at least one task, the computing power migration request is further used to trigger the first network side device to determine a target computing power node for computing power migration of a target task, and the target task is a task indicated by the computing power migration request.

Optionally, the computing power migration request includes at least one of the following:
a type of a computing power task carried on a source computing power node that needs to perform computing power migration;
a computing power requirement corresponding to the target task;
a computing power service information description corresponding to the target task;
computing power service performance or experience request information corresponding to the target task;
description information of the target task;
session container information of a network session N1 interface corresponding to the target task;
a protocol data unit session identifier corresponding to the target task;
integrity protection information of a maximum data rate of a terminal corresponding to the target task;
information about the source computing power node that needs to perform computing power migration;
data network name information corresponding to the target task; or network slice selection assistance information corresponding to the target task.

Optionally, the apparatus further includes a second execution module.

The second execution module is specifically configured to:
receive a deregistration indication sent by a second network side device, where the deregistration indication is sent after the second network side device receives migration information sent by the first network side device, and the deregistration indication is used to trigger a terminal to initiate network deregistration; and interact with the first network side device and the second network side device, execute network deregistration of the first terminal on a network slice corresponding to a first source computing power node and network re-registration on a network slice corresponding to the target computing power node, and migrate the target task to the target computing power node, where the first source computing power node is a computing power node before computing power migration is performed on the target task of the first terminal.

Optionally, the migration information includes at least one of the following: new network slice selection assistance information for computing power migration;
old network slice selection assistance information corresponding to deregistration;
re-registration indication information;
new data network name information for computing power migration; or
information about the target computing power node.

Optionally, the deregistration indication includes indication information indicating that a reason for this deregistration is computing power migration.

Optionally, the apparatus further includes:
a first updating module, configured to interact with a second network side device, and update a user configuration of the first terminal.

Optionally, the updated user configuration of the first terminal includes at least one of the following:
allowed network slice selection assistance information;
a correspondence between allowed network slice selection assistance information and subscribed network slice selection assistance information;
a correspondence between allowed network slice selection assistance information and configured network slice selection assistance information;
a data network name;
a terminal configuration policy; or
a terminal route selection policy.

The computing power task migration apparatus in this embodiment of this application may be an electronic device, for example, an electronic device with an operating system, or may be a component in the electronic device, for example, an integrated circuit or a chip. The electronic device may be a terminal. For example, the terminal may include but is not limited to the type of the terminal 11 listed above.

The computing power task migration apparatus provided in this embodiment of this application can implement the processes implemented in the method embodiment of FIG. 3, and achieve a same technical effect. To avoid repetition, details are not described herein again.

According to a seventh aspect, an embodiment of this application provides a computing power task migration apparatus, which may be applied to a computing power node. As shown in FIG. 12, the computing power task migration apparatus 120 may include the following module:
a first reporting module 1201, configured to report computing power capability information to a first network side device.

Optionally, the computing power capability information includes at least one of the following:
computing power resource usage information;
load information;
a computing power node identifier;
an internet protocol address of a computing power node;
overall computing power or capacity information of a computing power node;
a user identifier of a terminal that is accessed by a computing power node;
network slice selection assistance information corresponding to a computing power node;
data network name information corresponding to a computing power node;
a protocol data unit session identifier corresponding to a computing power task of a computing power node;
network slice selection assistance information of a computing power session of a computing power node; or data network name information of a computing power session of a computing power node.

Optionally, the apparatus further includes at least one of the following modules:
a second information interaction module, configured to: interact with the first network side device, and send migration computing power session-related information to the first network side device; or
a second preparation module, configured to interact with the first network side device to perform a migration preparation operation.

Optionally, the migration computing power session-related information includes at least one of the following:
a terminal identifier, a protocol data unit session identifier, network slice selection assistance information, or data network name information that are corresponding to a target task, where
the target task is a task on which computing power migration needs to be performed.

Optionally, the migration preparation operation includes at least one of the following:
resource application, computing power node configuration update, computing power service launch, computing power service activation, or computing power service registration. The computing power task migration apparatus in this embodiment of this application may be an electronic device, for example, an electronic device with an operating system, or may be a component in the electronic device, for example, an integrated circuit or a chip. The electronic device may be a network side device. For example, the network side device may include but is not limited to the type of the network side device 12 listed above.

The computing power task migration apparatus provided in this embodiment of this application can implement the processes implemented in the method embodiment of FIG. 4, and achieve a same technical effect. To avoid repetition, details are not described herein again.

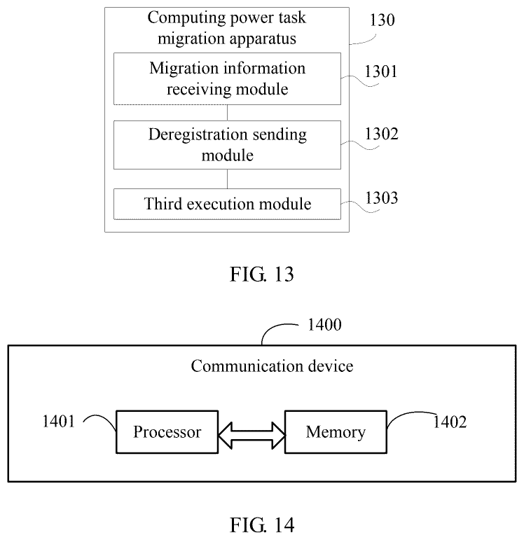

According to an eighth aspect, an embodiment of this application provides a computing power task migration apparatus, which may be applied to a second network side device. The second network side device may be, for example, an AMF. As shown in FIG. 13, the computing power task migration apparatus 130 may include the following modules:
a migration information receiving module 1301, configured to receive migration information sent by a first network side device;
a deregistration sending module 1302, configured to send a deregistration indication to a terminal corresponding to a target task, where the deregistration indication is used to trigger a terminal to initiate network deregistration, and the target task is a computing power task on which computing power migration needs to be performed; and
a third execution module 1303, configured to: interact with the first network side device and the terminal, execute network deregistration of the terminal on a network slice corresponding to a source computing power node and network re-registration on a network slice corresponding to a target computing power node, and migrate the target task to the target computing power node, where
the source computing power node is a computing power node before computing power migration is performed on the target task of the terminal, and the target computing power node is a computing power node after computing power migration is performed on the target task of the terminal.

Optionally, the migration information includes at least one of the following: new network slice selection assistance information for computing power migration;
old network slice selection assistance information corresponding to deregistration;
re-registration indication information;
new data network name information for computing power migration; or
information about the target computing power node.

Optionally, the deregistration indication includes indication information indicating that a reason for this deregistration is computing power migration.

Optionally, the apparatus further includes:
a second updating module, configured to: interact with the terminal based on the migration information, and update a user configuration of the terminal.

Optionally, the updated user configuration of the terminal includes at least one of the following:
allowed network slice selection assistance information;
a correspondence between allowed network slice selection assistance information and subscribed network slice selection assistance information;
a correspondence between allowed network slice selection assistance information and configured network slice selection assistance information;
a data network name;
a terminal configuration policy; or
a terminal route selection policy.

Optionally, the apparatus further includes:
a second receiving module, configured to receive a computing power migration request sent by the terminal; and
a second sending module, configured to forward the computing power migration request to the first network side device, where
the computing power migration request is used to request to perform computing power migration on at least one task, the computing power migration request is further used to trigger the first network side device to determine the target computing power node, and the target task is a task indicated by the computing power migration request.

Optionally, the computing power migration request includes at least one of the following:
a type of a computing power task carried on the source computing power node that needs to perform computing power migration;
a computing power requirement corresponding to the target task;
a computing power service information description corresponding to the target task;
computing power service performance or experience request information corresponding to the target task;
description information of the target task;
session container information of a network session N1 interface corresponding to the target task;
a protocol data unit session identifier corresponding to the target task;
integrity protection information of a maximum data rate of a terminal corresponding to the target task;
information about the source computing power node that needs to perform computing power migration;
data network name information corresponding to the target task; or network slice selection assistance information corresponding to the target task.

The computing power task migration apparatus in this embodiment of this application may be an electronic device, for example, an electronic device with an operating system, or may be a component in the electronic device, for example, an integrated circuit or a chip. The electronic device may be a network side device. For example, the network side device may include but is not limited to the type of the network side device 12 listed above.

The computing power task migration apparatus provided in this embodiment of this application can implement the processes implemented in the method embodiment of FIG. 5, and achieve a same technical effect. To avoid repetition, details are not described herein again.

Optionally, as shown in FIG. 14, an embodiment of this application further provides a communication device 1400, including a processor 1401 and a memory 1402. The memory 1402 stores a program or an instruction that can be run on the processor 1401. For example, when the communication device 1400 is a terminal, the program or the instruction is executed by the processor 1401 to implement the steps of the computing power task migration method embodiment in the second aspect, and a same technical effect can be achieved. When the communication device 1400 is a network side device, the program or the instruction is executed by the processor 1401 to implement the steps of the computing power task migration method embodiment in the first aspect, the third aspect, or the fourth aspect, and a same technical effect can be achieved. To avoid repetition, details are not described herein again.

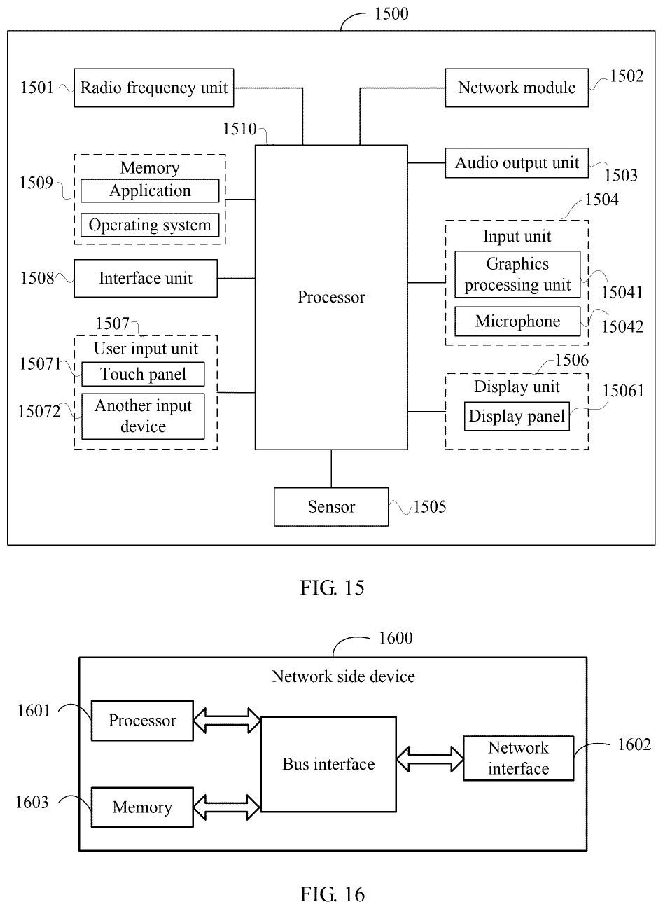

An embodiment of this application further provides a terminal. As shown in FIG. 15, FIG. 15 is a schematic diagram of a hardware structure of a terminal according to an embodiment of this application.

The terminal 1500 includes but is not limited to components such as a radio frequency unit 1501, a network module 1502, an audio output unit 1503, an input unit 1504, a sensor 1505, a display unit 1506, a user input unit 1507, an interface unit 1508, a memory 1509, and a processor 1510.

A person skilled in the art can understand that the terminal 1500 may further include the power supply (for example, a battery) that supplies power to each component. The power supply may be logically connected to the processor 1510 by using a power supply management system, so as to manage functions such as charging, discharging, and power consumption by using the power supply management system. The terminal structure shown in FIG. 15 constitutes no limitation on the terminal, and the terminal may include more or fewer components than those shown in the figure, or combine some components, or have different component arrangements. Details are not described herein.

It should be understood that, in this embodiment of this application, the input unit 1504 may include a graphics processing unit (GPU) 15041 and a microphone 15042, and the graphics processing unit 15041 processes image data of a still image or a video that is obtained by an image capturing apparatus (for example, a camera) in a video capturing mode or an image capturing mode. The display unit 1506 may include a display panel 15061. The display panel 15061 may be configured in a form such as a liquid crystal display or an organic light-emitting diode. The user input unit 1507 includes at least one of a touch panel 15071 or another input device 15072. The touch panel 15,071 is also referred to as a touchscreen. The touch panel 15071 may include two parts: a touch detection apparatus and a touch controller. The another input device 15072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1501 may transmit the downlink data to the processor 1510 for processing. In addition, the radio frequency unit 1501 may send uplink data to the network side device. Usually, the radio frequency unit 1501 includes but is not limited to an antenna, an amplifier, a transceiver, a coupler, a low noise amplifier, a duplexer, and the like.

The memory 1509 may be configured to store a software program or an instruction and various data. The memory 1509 may mainly include a first storage area for storing a program or an instruction and a second storage area for storing data. The first storage area may store an operating system, and an application or an instruction required by at least one function (for example, a sound playing function or an image playing function). In addition, the memory 1509 may be a volatile memory or a non-volatile memory, or the memory 1509 may include a volatile memory and a non-volatile memory. The nonvolatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 1509 in this embodiment of this application includes but is not limited to these memories and a memory of any other proper type.

The processor 1510 may include one or more processing units. Optionally, an application processor and a modem processor are integrated into the processor 1510. The application processor mainly processes an operating system, a user interface, an application, and the like. The modem processor mainly processes a wireless communication signal, for example, a baseband processor. It can be understood that, alternatively, the modem processor may not be integrated into the processor 1510.

The radio frequency unit 1501 is configured to send a computing power migration request to a first network side device, where the computing power migration request is used to request to perform computing power migration on at least one task, the computing power migration request is further used to trigger the first network side device to determine a target computing power node for computing power migration of a target task, and the target task is a task indicated by the computing power migration request.

Optionally, the computing power migration request includes at least one of the following:
a type of a computing power task carried on a source computing power node that needs to perform computing power migration;
a computing power requirement corresponding to the target task;
a computing power service information description corresponding to the target task;
computing power service performance or experience request information corresponding to the target task;
description information of the target task;
session container information of a network session N1 interface corresponding to the target task;
a protocol data unit session identifier corresponding to the target task;
integrity protection information of a maximum data rate of a terminal corresponding to the target task;
information about the source computing power node that needs to perform computing power migration;
data network name information corresponding to the target task; or network slice selection assistance information corresponding to the target task.

Optionally, the processor 1510 is further configured to:
control the radio frequency unit 1501 to receive a deregistration indication sent by a second network side device, where the deregistration indication is sent after the second network side device receives migration information sent by the first network side device, and the deregistration indication is used to trigger a terminal to initiate network deregistration; and
control the radio frequency unit 1501 to interact with the first network side device and the second network side device, execute network deregistration of the terminal on a network slice corresponding to a source computing power node and network re-registration on a network slice corresponding to the target computing power node, and migrate the target task to the target computing power node, where the source computing power node is a computing power node before computing power migration is performed on the target task of the terminal.

Optionally, the migration information includes at least one of the following: new network slice selection assistance information for computing power migration;
old network slice selection assistance information corresponding to deregistration;
re-registration indication information;
new data network name information for computing power migration; or
information about the target computing power node.

Optionally, the deregistration indication includes indication information indicating that a reason for this deregistration is computing power migration.

Optionally, the processor 1510 is further configured to:
control the radio frequency unit 1501 to interact with a second network side device, and update a user configuration of the terminal.

Optionally, the updated user configuration of the terminal includes at least one of the following:
allowed network slice selection assistance information;
a correspondence between allowed network slice selection assistance information and subscribed network slice selection assistance information;
a correspondence between allowed network slice selection assistance information and configured network slice selection assistance information;
a data network name;
a terminal configuration policy; or
a terminal route selection policy.

An embodiment of this application further provides a network side device. As shown in FIG. 16, the network side device 1600 includes a processor 1601, a network interface 1602, and a memory 1603. The network interface 1602 is, for example, a common public radio interface (CPRI).

Specifically, the network side device 1600 in this embodiment of the present invention further includes an instruction or a program that is stored in the memory 1603 and that can be run on the processor 1601. The processor 1601 invokes the instruction or the program in the memory 1603 to execute the method shown in FIG. 2 or FIG. 4 or FIG. 5, and a same technical effect is achieved. To avoid repetition, details are not described herein again.

An embodiment of this application further provides a readable storage medium. The readable storage medium stores a program or an instruction, and the program or the instruction is executed by a processor to implement the processes of the computing power task migration method embodiment in the first aspect, the second aspect, the third aspect, or the fourth aspect, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the computing power task migration method embodiment in the first aspect, the second aspect, the third aspect, or the fourth aspect, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the computer program/program product is executed by at least one processor to implement the processes of the computing power task migration method embodiment in the first aspect, the second aspect, the third aspect, or the fourth aspect, and a same technical effect can be achieved. To avoid repetition, details are not described herein again.

An embodiment of this application further provides a computing power task migration system, including a terminal and a network side device. The terminal may be configured to execute the steps of the computing power task migration method in the second aspect, and the network side device may be configured to execute the steps of the computing power task migration method in the first aspect, the third aspect, or the fourth aspect.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A computing power task migration method, wherein the method comprises:
determining, by a first network side device, a target task on which computing power migration needs to be performed;
determining, by the first network side device, a target computing power node for the computing power migration of the target task; and
executing, by the first network side device, a procedure of migrating the target task to the target computing power node.

2. The method according to claim 1, wherein the determining, by a first network side device, a target task on which computing power migration needs to be performed comprises:
receiving, by the first network side device, a computing power migration request sent by a first terminal, wherein the computing power migration request is used to request to perform computing power migration on at least one task; and
determining, as the target task by the first network side device, a task indicated by the computing power migration request, or
wherein the determining, by a first network side device, a target task on which computing power migration needs to be performed comprises:
determining, by the first network side device based on a computing power task and/or a computing power resource usage status of a computing power node, a source computing power node that needs to perform computing power migration, and determining a computing power task carried on the source computing power node as the target task.

3. The method according to claim 2, wherein the computing power migration request comprises at least one of the following:
a type of the computing power task carried on the source computing power node that needs to perform computing power migration;
a computing power requirement corresponding to the target task;
a computing power service information description corresponding to the target task;
computing power service performance or experience request information corresponding to the target task;
description information of the target task;
session container information of a network session N1 interface corresponding to the target task;
a protocol data unit session identifier corresponding to the target task;
integrity protection information of a maximum data rate of a terminal corresponding to the target task;
information about the source computing power node that needs to perform computing power migration;
data network name information corresponding to the target task; or
network slice selection assistance information corresponding to the target task.

4. The method according to claim 1, wherein the method further comprises:
receiving, by the first network side device, computing power capability information reported by at least one computing power node,
wherein the determining, by the first network side device, a target computing power node for the computing power migration of the target task comprises:
determining, by the first network side device, the target computing power node based on the computing power capability information, and
wherein the computing power capability information comprises at least one of the following:
computing power resource usage information;
load information;
a computing power node identifier;
an internet protocol address of a computing power node;
overall computing power or capacity information of a computing power node;
a user identifier of a terminal that is accessed by a computing power node;
network slice selection assistance information corresponding to a computing power node;
data network name information corresponding to a computing power node;
a protocol data unit session identifier corresponding to a computing power task of a computing power node;
network slice selection assistance information of a computing power session of a computing power node; or
data network name information of a computing power session of a computing power node.

5. The method according to claim 2, wherein the executing, by the first network side device, a procedure of migrating the target task to the target computing power node comprises:
sending, by the first network side device, migration information to a second network side device in response to the computing power migration request, wherein the migration information is used to instruct the second network side device to send a deregistration indication to the first terminal, and the deregistration indication is used to trigger a terminal to initiate network deregistration; and
interacting, by the first network side device, with the first terminal and the second network side device, executing network deregistration of the first terminal on a network slice corresponding to a first source computing power node and network re-registration on a network slice corresponding to the target computing power node, and migrating the target task to the target computing power node, wherein the first source computing power node is a computing power node before computing power migration is performed on the target task of the first terminal, or
wherein the target computing power node comprises at least one target node corresponding to a second terminal, and the second terminal comprises a terminal corresponding to the target task; and
the executing, by the first network side device, a procedure of migrating the target task to the target computing power node comprises:
sending, by the first network side device, migration information to a second network side device, wherein the migration information is used to instruct the second network side device to send a deregistration indication to each second terminal, and the deregistration indication is used to trigger a terminal to initiate network deregistration; and
interacting, by the first network side device, with each second terminal and the second network side device, executing network deregistration of the second terminal on a network slice corresponding to a second source computing power node and network re-registration on a network slice corresponding to a target node corresponding to the second terminal, and migrating a target task corresponding to the second terminal to the target node corresponding to the second terminal, wherein the second source computing power node is a computing power node before computing power migration is performed on the target task corresponding to the second terminal.

6. The method according to claim 5, wherein the migration information comprises at least one of the following:
new network slice selection assistance information for computing power migration;
old network slice selection assistance information corresponding to deregistration;
re-registration indication information;
new data network name information for computing power migration; or
information about the target computing power node, and
wherein the deregistration indication comprises indication information indicating that a reason for this deregistration is computing power migration.

7. The method according to claim 1, wherein the method further comprises at least one of the following:
interacting, by the first network side device, with a source computing power node of the target task to obtain migration computing power session-related information; or
interacting, by the first network side device, with the target computing power node to perform a migration preparation operation, wherein
the executing, by the first network side device, a procedure of migrating the target task to the target computing power node comprises:
executing, by the first network side device based on the migration computing power session-related information and/or the migration preparation operation, the procedure of migrating the target task to the target computing power node.

8. The method according to claim 7, wherein the migration computing power session-related information comprises at least one of the following:
a terminal identifier, a protocol data unit session identifier, network slice selection assistance information, or data network name information that are corresponding to the target task, and
wherein the migration preparation operation comprises at least one of the following:
resource application, computing power node configuration update, computing power service launch, computing power service activation, or computing power service registration.

9. A computing power task migration method, wherein the method comprises:
sending, by a first terminal, a computing power migration request to a first network side device, wherein the computing power migration request is used to request to perform computing power migration on at least one task, the computing power migration request is further used to trigger the first network side device to determine a target computing power node for computing power migration of a target task, and the target task is a task indicated by the computing power migration request.

10. The method according to claim 9, wherein the computing power migration request comprises at least one of the following:
a type of a computing power task carried on a source computing power node that needs to perform computing power migration;
a computing power requirement corresponding to the target task;
a computing power service information description corresponding to the target task;
computing power service performance or experience request information corresponding to the target task;
description information of the target task;
session container information of a network session N1 interface corresponding to the target task;
a protocol data unit session identifier corresponding to the target task;
integrity protection information of a maximum data rate of a terminal corresponding to the target task;
information about the source computing power node that needs to perform computing power migration;
data network name information corresponding to the target task; or
network slice selection assistance information corresponding to the target task.

11. The method according to claim 9, wherein the method further comprises:
receiving, by the first terminal, a deregistration indication sent by a second network side device, wherein the deregistration indication is sent after the second network side device receives migration information sent by the first network side device, and the deregistration indication is used to trigger a terminal to initiate network deregistration; and
interacting, by the first terminal, with the first network side device and the second network side device, executing network deregistration of the first terminal on a network slice corresponding to a first source computing power node and network re-registration on a network slice corresponding to the target computing power node, and migrating the target task to the target computing power node, wherein the first source computing power node is a computing power node before computing power migration is performed on the target task of the first terminal.

12. The method according to claim 11, wherein the migration information comprises at least one of the following:
new network slice selection assistance information for computing power migration;
old network slice selection assistance information corresponding to deregistration;
re-registration indication information;
new data network name information for computing power migration; or
information about the target computing power node, and
wherein the deregistration indication comprises indication information indicating that a reason for this deregistration is computing power migration.

13. The method according to claim 9, wherein the method further comprises:
interacting, by the first terminal, with a second network side device, and updating a user configuration of the first terminal, and
wherein the updated user configuration of the first terminal comprises at least one of the following:
allowed network slice selection assistance information;
a correspondence between allowed network slice selection assistance information and subscribed network slice selection assistance information;
a correspondence between allowed network slice selection assistance information and configured network slice selection assistance information;
a data network name;
a terminal configuration policy; or
a terminal route selection policy.

14. A computing power task migration method, wherein the method comprises:
reporting, by a computing power node, computing power capability information to a first network side device.

15. The method according to claim 14, wherein the computing power capability information comprises at least one of the following:
computing power resource usage information;
current load information;
a computing power node identifier;
an internet protocol address of a computing power node;
overall computing power or capacity information of a computing power node;
a user identifier of a terminal that is currently accessed by a computing power node;
network slice selection assistance information corresponding to a computing power node;
data network name information corresponding to a computing power node;
a protocol data unit session identifier corresponding to a current computing power task of a computing power node;
network slice selection assistance information of a current computing power session of a computing power node; or
data network name information of a current computing power session of a computing power node.

16. The method according to claim 14, wherein the method further comprises at least one of the following:
interacting, by the computing power node, with the first network side device, and sending migration computing power session-related information to the first network side device; or
interacting, by the computing power node, with the first network side device to perform migration preparation.

17. The method according to claim 16, wherein the migration computing power session-related information comprises at least one of the following:
a terminal identifier, a protocol data unit session identifier, network slice selection assistance information, or data network name information that are corresponding to a target task, wherein
the target task is a task on which computing power migration needs to be performed, and
wherein the migration preparation comprises at least one of the following:
resource application, computing power node configuration update, computing power service launch, computing power service activation, or computing power service registration.

18. A network side device, comprising a processor and a memory, wherein the memory stores a program or an instruction that can be run on the processor, and the program or the instruction is executed by the processor to implement the steps of the computing power task migration method according to claim 1.

19. A network side device, comprising a processor and a memory, wherein the memory stores a program or an instruction that can be run on the processor, and the program or the instruction is executed by the processor to implement the steps of the computing power task migration method according to claim 14.

20. A terminal, comprising a processor and a memory, wherein the memory stores a program or an instruction that can be run on the processor, and the program or the instruction is executed by the processor to implement the steps of the computing power task migration method according to claim 9.
